(19) United States
(12) Patent Application Publication
(10) Pub. No.: US 2022/0258664 A1
(43) Pub. Date: Aug. 18, 2022

(54) INTELLIGENT REAR-END COLLISION PREVENTING DYNAMIC COLOR-CHANGING BRAKE LIGHT FOR AUTOMOBILE

(71) Applicant: LI, Jianhua, Shanxi (CN)

(72) Inventor: Jianhua Li, Shanxi (CN)

(21) Appl. No.: 17/427,484

(22) PCT Filed: Nov. 19, 2019
(86) PCT No.: PCT/CN2019/119526

§ 371 Date: Jul. 30, 2021

(30) Foreign Application Priority Data
Jan. 30, 2019 (CN) 201910090230.4

(51) Int. Cl. B60Q 1/44; H05B 45/20; H05B 45/46

(52) U.S. Cl. CPC B60Q 1/44; B60Q 2400/20; H05B 45/46; H05B 45/20

(57) ABSTRACT

An intelligent rear-end collision preventing dynamic color-changing brake light for an automobile, including a signal display panel (1), a control panel (2), and a sensor (3). The signal display panel (1) comprises a high-brightness LED light group (4) and a display circuit board (5); the high-brightness LED light group (4) is electrically connected to the display circuit board (5); the high-brightness LED light group (4) comprises two-color LED lights; the control panel (2) is provided with a single-chip microprocessor chip (6) and an amplifier (7); the single-chip microprocessor chip (6) and the amplifier (7) are electrically connected to the control panel (2) respectively; and the sensor (3) is a hall linear displacement sensor.

### TECHNICAL FIELD

The present disclosure relates to the technical field of brake lights, and more specifically relates to an intelligent rear-end collision preventing dynamic color-changing brake light for an automobile.

### BACKGROUND ART

When existing automobiles are running at a high speed, people need to press a brake lightly sometimes, and need to press the brake in emergency sometimes. However, in both cases, only one red light is lightened in an existing light bulb, and these details cannot be distinguished, which will cause long-term mental tension of a driver of a following vehicle. The emergency braking will make it difficult for the following vehicle to make correct judgments in time, ending up with a rear-end collision accident. This situation happens all the time, especially on highways, where collisions are often caused by dozens or even hundreds of automobiles. In modern cities, cars are overcrowded, and collisions occur frequently due to the same reason. The main reason is that when an automobile is braked, details such as the strength of braking and the emergency level of braking cannot be distinguished by existing brake lights, so that a driver in a following automobile brakes the automobile late or hesitantly because there is obvious quantified visual perception.

The patent CN201120183114.6 discloses a high-position brake light display device. A brake light includes a plurality of columns of LEDs. A displacement sensor detects a displacement of a pedal. A body control module (BCM) controls the multiple columns of LEDs to be lightened in stages. The middle column is a first stage, and one column is added on each of the left and right of the middle column and is a second stage, so as to warn vehicles behind according to a braking degree. The brake light is intelligently controlled through the BCM. A brake control program must be set when an automobile is produced, so it is difficult to transform the brake light in the existing automobile. Furthermore, braking warning grades are displayed from the middle in a broadening manner. Due to the action of a viewing angle of people, it is hard to distinguish the braking level in this manner. The driver can only see a relatively large red light mass and a relatively small red light mass or a relatively bright red light mass and a relatively dark red light mass. The patent CN99106564.6 discloses a large-size dynamic color-changing rear-view warning light. A magnetic circuit type sensor senses a brake position, and an A/D converter outputs a plurality of paths of control signals to an LED display panel to realize dynamic displaying. The LED display panel displays the granularity and speed in a braking process by using a duty ratio where red color and yellow change dynamically. The brake uses a magnetic circuit sensor which has poor consistency, large size and inconvenient installation. An analog and digital hybrid circuit is used to realize control, so that the consistency is poor, elements are easy to age, and functions are monotonous.

In summary, it is necessary to further improve the existing technology.

### SUMMARY

The present disclosure aims to provide an intelligent rear-end collision dynamic color-changing brake light for an automobile, which solves the problems that an existing brake light shows poor visuality and warning property, elements of a brake warning system are easy to age and hard to maintain, and the application range is small.

In order to achieve the above purposes, the technical solution provided by the present disclosure is as follows. An intelligent rear-end collision dynamic color-changing brake light for an automobile includes a signal display panel, a control panel, and a sensor.

The signal display panel includes a high-brightness LED light group and a display circuit board; the high-brightness LED light group is electrically connected to the display circuit board; the high-brightness LED light group includes two-color LED lights including yellow LED lights and red LED lights; the control panel is provided with a single-chip microprocessor chip and an amplifier; the single-chip microprocessor chip and the amplifier are electrically connected to the control panel respectively; the sensor is a hall linear displacement sensor; the signal display panel and the control panel are electrically connected through a bidirectional pin; the sensor is electrically connected to the single-chip microprocessor chip; the sensor is arranged outside a brake system structure and is close to one side near a brake pedal; and a side of the brake pedal close to the sensor is provided with a sampling magnet. When the brake pedal is pressed, the sampling magnet and the sensor are driven to move face to face. The sensor senses changing distance information and outputs an analog electric signal of a corresponding change; the single-chip microprocessor chip converts the received analog electric signal of the sensor into 8 to 10 paths of red control signal and 8 to 10 paths of yellow control signals which are connected to 8 to 10 paths of red LED control ends and 8 to 10 paths of yellow LED control ends via an array amplifier to respectively control 8 to 10 groups of red lights and yellow lights to be increased in order, decreased progressively in order or change color in order, thereby controlling operation of the signal display panel.

Further, an operation voltage of the signal display panel includes 12 v and 24 v; and an operation voltage of the control panel includes 12 v and 24 v.

Further, the high-brightness LED light group is detachably connected to the display circuit board.

Further, the high-brightness LED light group at least includes 8 columns of LED lights, 2 to 5 LED lights.

Further, the high-brightness LED light group at least includes 8 to 10 groups of LED lights, and the LED lights of the same group are connected in series; and all the groups of LED lights are connected in parallel.

Further, the single-chip microprocessor chip uses STC15F402EA, and the amplifier uses ULN2003N.

Further, the high-brightness LED light group on the display circuit board controls different display states according to programs programmed by the single-chip microprocessor chip to be used as various display states such as a brake light, a fog light, a left turn light, a right turn light, a clearance light, and a strong warning light.

Further, the control programs of the high-brightness LED light group on the display circuit board are preferably sequenced as follows: a brake light program, a left and right turn program, a fog light program, a clearance light program, and a strong warning light program.

Compared with the existing technology, the present disclosure has the beneficial effects:

The present disclosure provides the intelligent rear-end collision preventing dynamic color-changing brake light for the automobile. An intelligent single-chip microprocessor chip and a microcomputer control technology is used to control different display combinations of the LED group of the brake light to show different warning functions, such as displaying the strength of braking and displaying turn, and the volume of the control panel is greatly reduced. The hall linear distance sensor used is small in volume and high in sensitivity, and the reliability of the sensor is improved. The signal display circuit board and the control panel are tightly connected back to back by a bidirectional pin, so that the problem of reduction of the reliability of a hidden broken circuit caused by fatigue due to long-time flexible wire connection is avoided, and the problem in transmission of multiple signal lines is solved; meanwhile, the reliability of a product in a vibrating state is improved. Since the red and yellow lights are used, the prompt is obvious, and it is convenient for distinguishing the strength of braking to provide a good warning effect for following vehicles. The brake light provided by the present disclosure is simple in structure, convenient to assemble and disassemble, suitable for refitting of an existing vehicle brake light and also suitable for installation of newly produced vehicle brake lights. Detachable structures are provided between all the components, so that the use is flexible, the maintenance is convenient, the vibration damping effect is good, and the warning effect is strong.

### BRIEF DESCRIPTION OF THE DRAWINGS

FIG. 1 is a FIG. 1 is a schematic diagram of an intelligent rear-end collision preventing dynamic color-changing brake light for an automobile provided by the present disclosure;

FIG. 2 is a side view of an intelligent rear-end collision preventing dynamic color-changing brake light for an automobile provided by the present disclosure;

FIG. 3a, FIG. 3b, FIG. 3c, and FIG. 3d are program graphs illustrating that the intelligent rear-end collision preventing dynamic color-changing brake light for an automobile provided by the present disclosure operates in sequence; and

FIG. 4 is a schematic circuit diagram of an intelligent rear-end collision preventing dynamic color-changing brake light for an automobile provided by the present disclosure.

Reference signs in the drawings: 1: signal display panel; 2: control panel; 3: sensor; 4: high-brightness LED light group; 5: display circuit board; 6: single-chip microprocessor chip; 7: amplifier; 8: bidirectional pin; 9: brake pedal; and 10: sampling magnet.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the described embodiments are only a part of the embodiments of the present disclosure, rather than all the embodiments. Based on the embodiments in the present disclosure, all other embodiments obtained by those of ordinary skill in the art without creative work shall fall within the protection scope of the present disclosure.

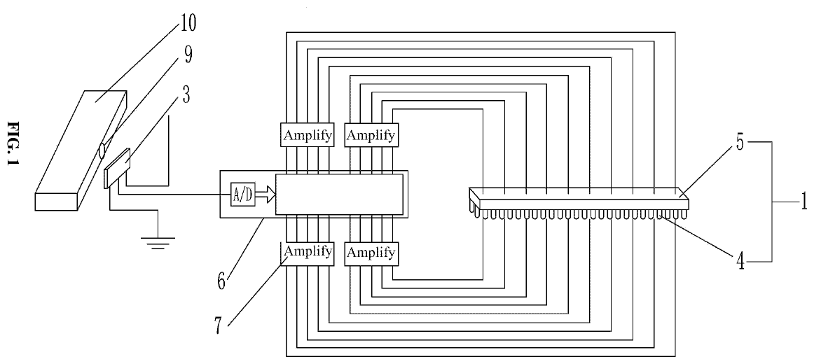

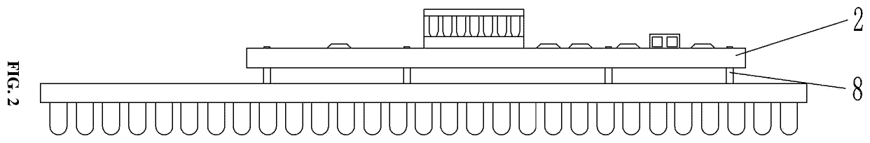

As shown in FIG. 1 to FIG. 2, an intelligent rear-end collision preventing dynamic color-changing brake light for an automobile includes a signal display panel 1, a control panel 2 and a sensor 3. The signal display panel 1 includes a high-brightness LED light group 4 and a display circuit board 5; the high-brightness LED light group 4 is electrically connected to the display circuit board 5; the high-brightness LED light group 4 includes two-color LED lights including yellow LED lights and red LED lights; the control panel 2 is provided with a single-chip microprocessor chip 6 and an amplifier 7; the single-chip microprocessor chip 6 and the amplifier 7 are electrically connected to the control panel 2 respectively; the sensor 3 is a hall linear displacement sensor; the signal display panel 1 and the control panel 2 are electrically connected through a bidirectional pin 8; the sensor 3 is electrically connected to the single-chip microprocessor chip 6; the sensor 3 is arranged outside a brake system structure and is close to one side near a brake pedal 9; and a side of the brake pedal 9 close to the sensor 3 is provided with a sampling magnet 10. When the brake pedal 9 is pressed, the sampling magnet 10 and the sensor 3 are driven to move face to face. The sensor 3 senses changing distance information and outputs an analog electric signal of a corresponding change; the single-chip microprocessor chip 7 converts the received analog electric signal of the sensor 3 into 8 to 10 paths of red control signal and 8 to 10 paths of yellow control signals which are connected to 8 to 10 paths of red LED control ends and 8 to 10 paths of yellow LED control ends via an array amplifier 8 to respectively control 8 to 10 groups of red lights and yellow lights to be increased in order, decreased progressively in order or change color in order, thereby controlling operation of the signal display panel 1.

In the present embodiment, the high-brightness LED light group 4 is detachably connected to the display circuit board 1. The high-brightness LED light group 4 at least includes 8 columns of LED lights, 2 to 5 LED lights in each column. The high-brightness LED light group 4 at least includes 8 to 10 groups of LED lights, and the LED lights of the same group are connected in series; and all the groups of LED lights are connected in parallel.

In the present embodiment, an operation voltage of the signal display panel 1 includes 12 v and 24 v; and an operation voltage of the control panel 2 includes 12 v and 24 v.

In the present embodiment, the single-chip microprocessor chip 6 uses STC15F402EA, and the amplifier 7 uses ULN2003N.

In the present disclosure, a braking process is quantified into a plurality of levels. A changing red light is directly related to the strength of braking. When an accelerator is released to the end, the braking light is initiated. The signal can be obtained from a body control module (BCM), such as an output signal wire terminal of an automobile tachometer. As the strength for pressing the brake changes from low to high, one group of red lights that are lightened are transitions to all red lights that are lightened. The magnitude of the strength of braking can be directly observed by means of the number of red lights that are lightened. In a normal working method, all the yellow lights are lightened before the brake is pressed. When the brake is pressed slightly, one group of red lights at one end start to be on, and the yellow lights at the corresponding positions are off. In this way, the number of red lights that are lightened represents changes of the strength of braking from low to high. By means of a dynamically changing ratio of red lights to yellow lights and a rate of change of the red lights, the magnitude of the strength for pressing the brake and the emergency degree of pressing of the brake are intuitively and accurately displayed. Ten display states of the brake light correspond to the 8 to 10 groups of quantified levels of the strength of braking according to the strength of braking.

The present disclosure uses a single-chip microprocessor chip control technology, and controls the display states of the brake light through program programming to express a variety of different warning displaying, including left turn, right turn, fog light, night clearance light, strong warning displaying, etc. The braking program is a main program, and other programs are subprograms. The main program can interrupt the operation of other subprograms. The high-brightness LED light group 4 on the display circuit board 5 can control different display states according to the programs programmed by the single-chip microprocessor chip 6 to be used as a brake light, a fog light, a left turn light, a right turn light, a clearance light, and a strong warning light.

The control programs of the high-brightness LED light group 4 on the display circuit board 5 are preferably sequenced as follows: a brake light program, a left and right turn program, a fog light program, a clearance light program, and a strong warning light program.

When the brake light is in a braking state, the strength of braking is divided into 8 to 10 groups of levels, and the braking state of the 8 to 10 groups of levels is associated with 8 to 10 groups of LED lights in sequence. The number of red LED lights that are lightened shows the magnitude of the strength of braking, and other LED lights are in yellow. The red LED lights start to increase or decrease progressively in sequence from one end of the brake light. For example, when the strength of braking is divided into 10 groups, if the strength of braking is 4, 4 adjacent groups of red LED lights at the left end (or the right end) of the brake light are lightened, and 6 adjacent groups of yellow LED lights at the right end (or the left end) of the brake light are lightened. When the brake is not pressed, 10 groups of yellow lights are displayed as the brake light. For example, when the strength of braking is divided into 8 groups, if the strength of braking is 3, 3 adjacent groups of red LED lights at the left end (or the right end) of the brake light are lightened, and 5 adjacent groups of yellow LED lights at the right end (or the left end) of the brake light are lightened. It can also be displayed in another way: the red lights are lightened in sequence from the middle to both ends, and the yellow lights at the corresponding positions are extinguished in sequence.

When the brake light shows left turn, three adjacent groups of yellow lights form a big light mass that rolls from right to left continuously and cyclically.

When the brake light shows right turn, three adjacent groups of yellow lights form a big light mass that rolls from left to right continuously and cyclically.

When the brake light shows a fog light, the yellow LED lights are simultaneously lightened and extinguished according to a rhythm.

When the brake light shows a night clearance light, 1 to 2 groups of red lights at both ends of the brake light to play a clearance role of a clearance light.

When the brake light shows strong warning displaying, the yellow LED lights are all lightened. After 5 to 6 minutes, the red LED light and the yellow LED light are alternately lightened. That is, all the red lights are on in one period, and all the yellow lights are on in the next period, alternately. The operation that triggers the strong warning displaying is triggered: a full yellow warning state is displayed when the accelerator is not pressed, and the strong warning displaying is automatically displayed after 5 to 6 minutes: the state of not pressing the accelerator is an idling state or a temporary parking state, i.e., a powered-on state where the engine is out but the key is switched on.

In the present embodiment, the various changes of the high-brightness LED light group 4 are programmed by various software programs in the single-chip microprocessor chip 6, and are controlled and realized by subprograms. The priority of the display states of the high-brightness LED light group 4 is as follows: the braking state, the left turn or right turn, the fog light, the clearance light, and the strong warning displaying.

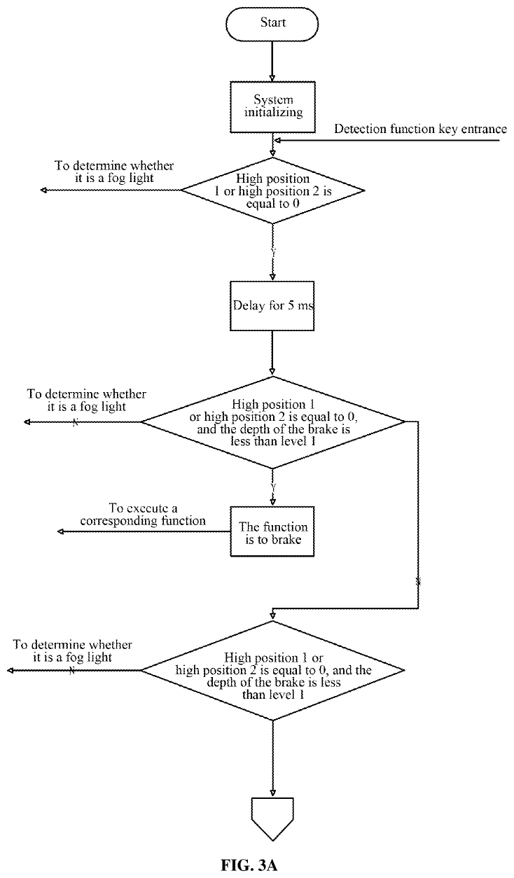

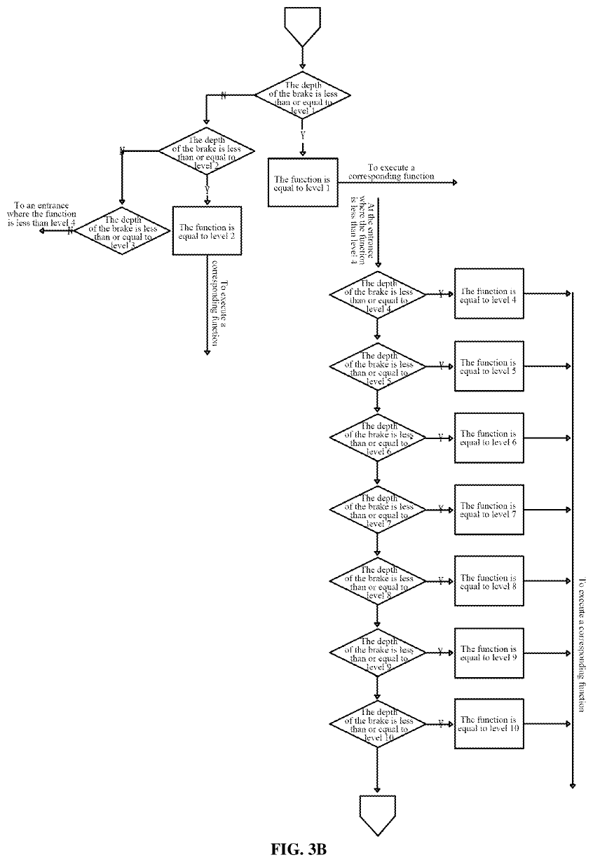

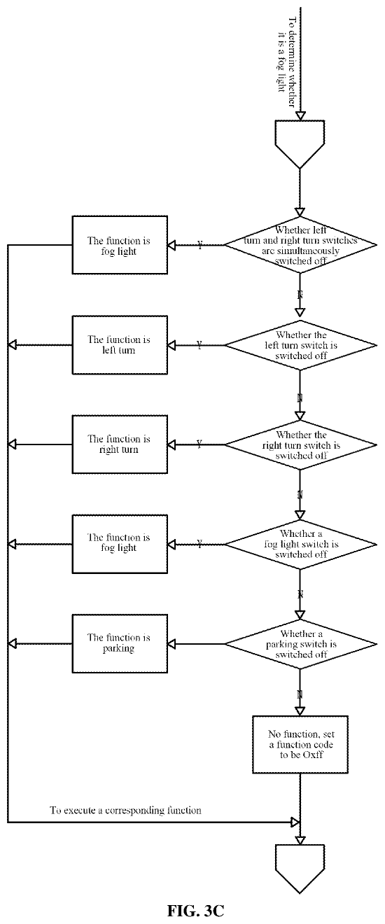

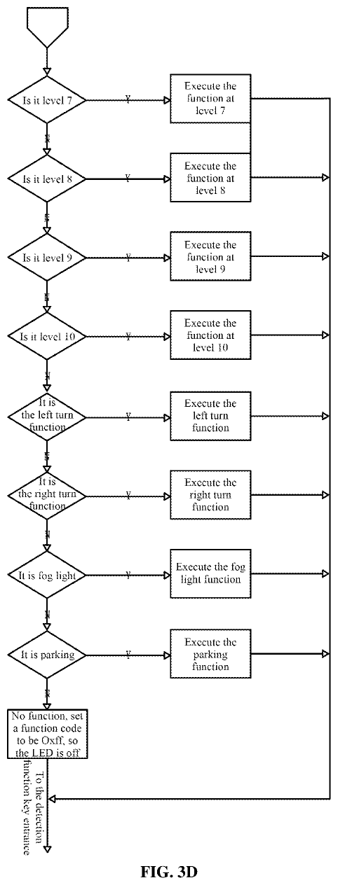

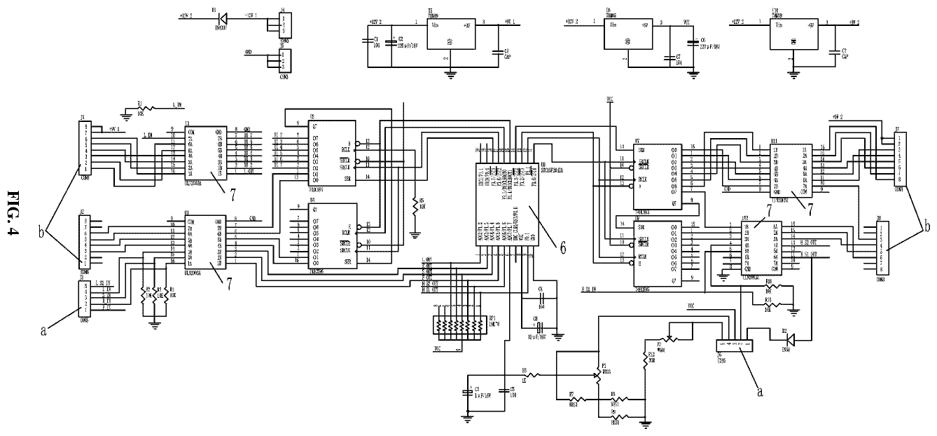

FIG. 3a, FIG. 3b, FIG. 3c, and FIG. 3d are program graphs illustrating that the intelligent rear-end collision preventing dynamic color-changing brake light for an automobile provided by the present disclosure operates in sequence. FIG. 3a, FIG. 3b, FIG. 3c, and FIG. 3d are sequentially connected to form a complete program control diagram, i.e., the intelligent rear-end collision preventing dynamic color-changing brake light for an automobile. FIG. 4 is a schematic circuit diagram illustrating that a main board is a circuit board. In the present embodiment, four amplifiers 7 are provided, a for a sampling input part for all types of signals, and b for a control part of all signals output to LEDs for displaying.

The above describes preferred embodiments of the present disclosure in detail, but the present disclosure is not limited to the above-mentioned embodiments. Various changes can be further made within the knowledge scope of those skilled in the art and without departing from the concept of the present disclosure. The various changes shall all fall within the protection scope of the present disclosure.

What is claimed is:

1. An intelligent rear-end collision preventing dynamic color-changing brake light for an automobile, comprising a signal display panel (1), a control panel (2) and a sensor (3), wherein the signal display panel (1) comprises a high-brightness LED light group (4) and a display circuit board (5); the high-brightness LED light group (4) is electrically connected to the display circuit board (5); the high-brightness LED light group (4) comprises two-color LED lights comprising yellow LED lights and red LED lights; the control panel (2) is provided with a single-chip microprocessor chip (6) and an amplifier (7); the single-chip microprocessor chip (6) and the amplifier (7) are electrically connected to the control panel (2) respectively; the sensor (3) is a hall linear displacement sensor; the signal display panel (1) and the control panel (2) are electrically connected through a bidirectional pin (8); the sensor (3) is electrically connected to the single-chip microprocessor chip (6); the sensor (3) is arranged outside a brake system structure and is close to one side near a brake pedal (9); a side of the brake pedal (9) close to the sensor (3) is provided with a sampling magnet (10); when the brake pedal (9) is pressed, the sampling magnet (10) and the sensor (3) are driven to move face to face; the sensor (3) senses changing distance information and outputs an analog electric signal of a corresponding change; the single-chip microprocessor chip (7) converts the received analog electric signal of the sensor (3) into 8 to 10 paths of red control signal and 8 to 10 paths of yellow control signals which are connected to 8 to 10 paths of red LED control ends and 8 to 10 paths of yellow LED control ends via an array amplifier (8) to respectively control 8 to 10 groups of red lights and yellow lights to be increased in order, decreased progressively in order or change color in order, thereby controlling operation of the signal display panel (1).

2. The intelligent rear-end collision preventing dynamic color-changing brake light for the automobile according to claim 1, wherein an operation voltage of the signal display panel (1) 12 v and 24 v; and an operation voltage of the control panel (2) comprises 12 v and 24 v.

3. The intelligent rear-end collision preventing dynamic color-changing brake light for the automobile according to claim 1, wherein the high-brightness LED light group (4) is detachably connected to the signal display circuit board (1).

4. The intelligent rear-end collision preventing dynamic color-changing brake light for the automobile according to claim 1, wherein the high-brightness LED light group (4) at least comprises 8 columns of LED lights, 2 to 5 LED lights in each column.

5. The intelligent rear-end collision preventing dynamic color-changing brake light for the automobile according to claim 1, wherein the high-brightness LED light group (4) comprises 8 to 10 groups of LED lights, and the LED lights of the same group are connected in series; and all the groups of LED lights are connected in parallel.

6. The intelligent rear-end collision preventing dynamic color-changing brake light for the automobile according to claim 1, wherein the single-chip microprocessor chip (6) uses STC15F402EA, and the amplifier (7) uses ULN2003N.

7. The intelligent rear-end collision preventing dynamic color-changing brake light for the automobile according to claim 1, wherein the high-brightness LED light group (4) on the display circuit board (5) controls different display states according to programs programmed by the single-chip microprocessor chip (6) to be used as various display states such as a brake light, a fog light, a left turn light, a right turn light, a clearance light, and a strong warning light.

8. The intelligent rear-end collision preventing dynamic color-changing brake light for the automobile according to claim 7, wherein the control programs of the high-brightness LED light group (4) on the display circuit board (5) are preferably sequenced as follows: a brake light program, a left and right turn program, a fog light program, a clearance light program, and a strong warning light program.
